(19) United States
(12) Patent Application Publication
(10) Pub. No.: US 2007/0196789 A1
(43) Pub. Date: Aug. 23, 2007

(54) Compass tool display object for navigating a tooth model

(75) Inventor: Hubert L. Lacey III, Dallas, TX (US)

Correspondence Address: LAW OFFICE OF DAVID H. JUDSON, 15950 DALLAS PARKWAY, SUITE 225, DALLAS, TX, 75248, US

(73) Assignee: D4D Technologies, LP

(21) Appl. No.: 11/358,966

(22) Filed: Feb. 22, 2006

(51) Int. Cl. A61C 11/00

(52) U.S. Cl. 433/213

(57) ABSTRACT

A compass tool having a center, together with a set of orientation arrows that correspond to pairs of anatomical reference points in a human mouth. These pairs include: mesial-distal, buccal-lingual, and occlusal-gingival (or occlusal-cervical). An image (or, more generally, a representation) of a given tooth under design is located at the tool center, and this image preferably exhibits a basic tooth geometry according to the number of the tooth being designed. If the user changes tooth numbers, preferably the tooth image at the center of the compass tool is changed. The compass tool is displayed on a given portion of a display while a tooth restoration model is displayed on a primary canvas. To facilitate the design process, selection of a given arrow in the compass tool rotates the tooth restoration model on the primary canvas to a viewpoint along the selected anatomical axis. In addition, selection of the tooth image at the center of the compass tool generates an orientation graphic around the tooth model on the primary canvas.

### BACKGROUND OF THE INVENTION

1. Technical Field

The present invention relates to computer-assisted techniques for creating dental restoration models.

2. Brief Description of the Related Art

The art of fabricating custom-fit prosthetics in the dental field is well-known. Prosthetics are replacements for tooth or bone structure. They include restorations, replacements, inlays, onlays, veneers, full and partial crowns, bridges, implants, posts, and the like. Typically, a dentist prepares a tooth for a restoration by removing existing anatomy, which is then lost. The resultant prepared area (a “preparation”) is then digitized (or, in the alternative, a dental impression is taken) for the purpose of constructing a restoration. The restoration itself may be constructed through a variety of techniques including manually constructing the restoration, using automated techniques based on computer algorithms, or a combination of manual and automated techniques.

Computer-assisted techniques have been developed to generate three-dimensional (“3D”) visual images of physical objects, such as a dental preparation. In general, the 3D image may be generated by a computer that processes data representing the surfaces and contours of a physical object. The computer displays the 3D image on a screen or a computer monitor. The computer typically includes a graphical user interface (GUI). Data is generated by optically scanning the physical object and detecting or capturing the light reflected off of the object. Based on processing techniques, the shape, surfaces and/or contours of the object may be modeled by the computer.

During the process of creating a tooth restoration model, one or more user interface tools may be provided to facilitate the design process. One known display technique uses a computer monitor that, under software control, displays a 3-dimensional representation of a tooth model. To facilitate navigation about the model, the display includes a set of buttons, with each button corresponding to a pair of anatomical reference points in the human mouth. In particular, a first button corresponds to the mesial-distal axis, a second button corresponds to the buccal-lingual axis, and a third button corresponds to the occlusal-cervical axis. Using these buttons, the developer can control the representation of the model on the interface.

### BRIEF SUMMARY OF THE INVENTION

It is an object of the present invention to provide graphical user interface (GUI) display object tool that facilitates navigation in and about a representation of a tooth model.

It is a more particular object of the invention to provide such a tool in the form of a compass having a center portion, together with a set of orientation arrows that correspond to pairs of anatomical reference points in a human mouth. These pairs include: mesial-distal, buccal-lingual, and occlusal-gingival (or occlusal-cervical). An image (or, more generally, a representation) of a given tooth under design is located at the tool center, and this image preferably exhibits a basic tooth geometry according to a number of the tooth being designed. If the user changes tooth numbers, preferably the tooth image at the center of the compass tool is changed. The compass tool is displayed on a given portion of a display while a tooth restoration model is displayed on a primary canvas. To facilitate the design process, selection of a given arrow in the compass tool rotates the tooth restoration model on the primary canvas to a viewpoint along the selected anatomical axis. In addition, selection of the tooth image at the center of the compass tool generates an orientation graphic around the tooth model on the primary canvas.

Other features and advantages of the invention will be apparent to one with skill in the art upon examination of the following figures and detailed description. It is intended that all such additional features and advantages be included within this description, be within the scope of the invention, and be protected by the claims.

### BRIEF DESCRIPTION OF THE DRAWINGS

The invention may be better understood with reference to the following drawings and its accompanying description. Unless otherwise stated, the components in the figures are not necessarily to scale, emphasis instead being placed upon illustrating the principles of the invention. Moreover, in the figures, like referenced numerals designate corresponding parts throughout the different views.

FIG. 1 illustrates a computer system in which the inventive method may be implemented;

FIG. 2 depicts a portion of a display GUI illustrating the compass tool and an associated primary design canvas;

FIG. 3 depicts a preferred implementation of the compass tool without inclusion of a tooth image;

FIG. 4 depicts the compass tool with a bicuspid image;

FIG. 5 depicts the compass tool with a molar image;

FIG. 6 illustrates how selection of a given compass tool arrow re-orients the tooth model on the primary canvas according to the present invention;

FIG. 7 illustrates another feature of the invention whereby selection of the given tooth at the center of the compass tool generates an orientation graphic around the tooth on the primary canvas; and

FIG. 8 is a representative odontogram that is displayed on a display screen and from which a user can select a given tooth from a tooth library.

### DETAILED DESCRIPTION

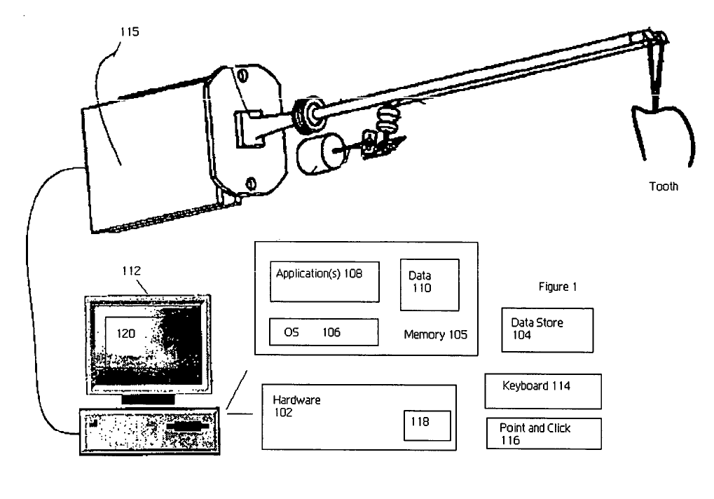

The present invention provides a display method, preferably implemented in a computer. For illustrated purposes, the computer is a single machine, but this is not a limitation. More generally, the method is implemented using one or more computing-related entities (systems, machines, processes, programs, libraries, functions, code, or the like) that facilitate or provide the inventive functionality. As seen in FIG. 1, a representative machine is a computer running commodity hardware, an operating system, an application runtime environment, and a set of applications or processes (e.g., linkable libraries, native code, or the like, depending on platform), that provide the functionality of a given system or subsystem. The invention may be implemented in a standalone machine, or across a distributed set of machines.

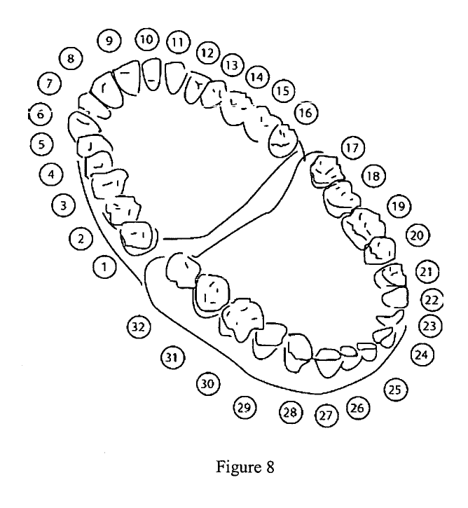

More specifically, the computer 100 comprises hardware 102, suitable storage 104 and memory 105 for storing an operating system 106, one or more software applications 108 and data 110, conventional input and output devices (a display 112, a keyboard 114, a point-and-click device 116, and the like), other devices 118 to provide network connectivity, and the like. A laser digitizer system 115 is used to obtain optical scans, e.g., from preexisting anatomy. A representative digitizer system is described in commonly-owned, co-pending published application No. 20040254476, the disclosure of which is incorporated herein by reference. Using a conventional graphical user interface 120, an operator can view and manipulate models as they are rendered on the display 112. The computer preferably also includes a data store comprising a library of anatomical reference data for a set of teeth. Using a display odontogram such as shown in FIG. 8, a user can select a given tooth (by its tooth number) and obtain given reference data stored in the library. The odontogram comprises a set of clickable graphics, with each graphic corresponding to one of the identified teeth.

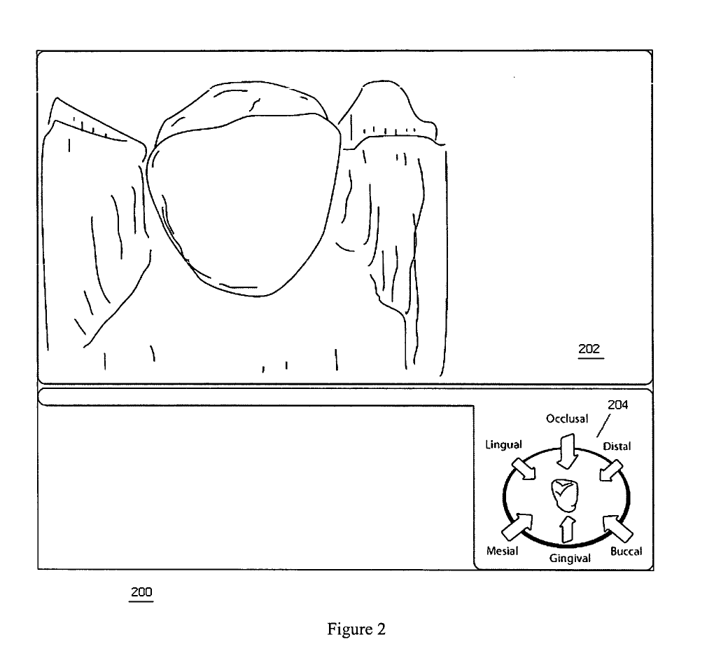

FIG. 2 illustrates a portion of a representative graphical user interface 200 showing a primary canvas region 202 and a control object 204 according to the present invention. The control object 204 preferably is configured as a compass tool that comprises up to six (6) distinct regions that are selectable. As will be seen, each region preferably corresponds to a given anatomical aspect of the human mouth. Once selected, a design model being displayed on the primary canvas region is adjusted (typically by rotating, twisting, or the like) such that a viewpoint is then along a specified axis as determined by the selected region.

Preferably, the compass tool is a single control that is generated in software (e.g., a set of computer program instructions) executable in at least one processor. A representative implementation is computer program product comprising a tangible medium on which given computer code is written, stored or otherwise embedded. The computer code provides a set of display functions that are now described.

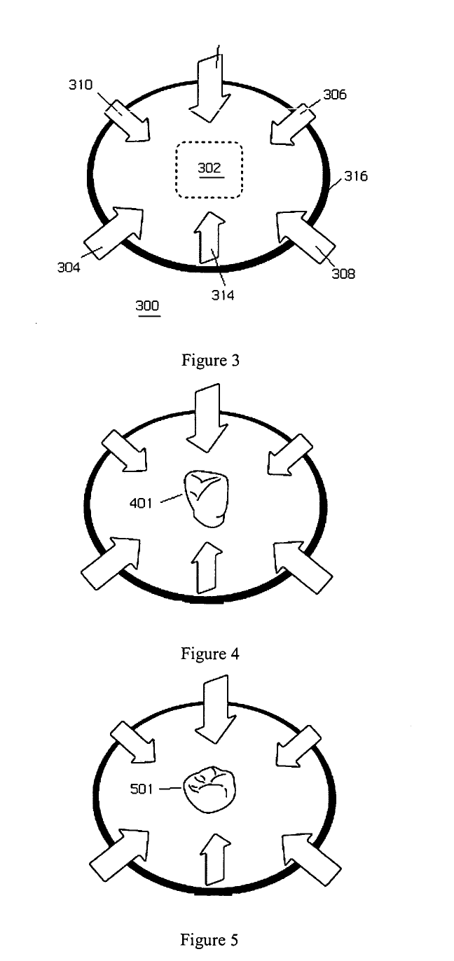

As seen in FIG. 3, the compass tool 300 comprises having a center or center portion 302, together with a set of orientation arrows 304, 306, 308, 310, 312 and 314 that correspond to pairs of anatomical reference points in a human mouth. These pairs include: mesial-distal, buccal-lingual, and occlusal-gingival (or occlusal-cervical). With respect to the anatomical reference points comprising the mesial-distal pair, the set of orientation arrows include a first arrow 304 identified as mesial, and a second opposed arrow 306 identified as distal. With respect to the anatomical reference points comprising the buccal-lingual pair, the set of orientation arrows include a first arrow 308 identified as buccal, and a second opposed arrow 310 identified as lingual. With respect to the anatomical reference points comprising the occlusal-gingival pair, the set of orientation arrows include a first arrow 312 identified as occlusal, and a second opposed arrow 314 identified as gingival (or “cervical”). The particular identifiers are not meant to be taken as limiting, as any convenient nomenclature, designs, icons, and the like can be used. In addition, the “arrows” may be formed as lines or other geometric figures or representations. The wording and the arrows may be conflated together. Each arrow preferably is a bitmap (or similar construct) that can be selected, e.g., by a conventional point-and-click device, by keyboard entry, or by programmatic means. In one embodiment, a mouse over function can be implemented on a given arrow to cause a given display function, such as a highlight, or a color change. Preferably, each of the arrows is displayed in a given color distinct from the colors of the other arrows. Thus, e.g., these colors may include, without limitation, red, blue, orange, green, yellow, blue, and the like. As indicated in FIG. 3, the compass tool 300 preferably also includes a representation of a ring 316, which serves the useful purpose of connoting a planar association of the four arrows comprising the mesial-distal and buccal-lingual aspects. This ring may be omitted if desired, or the ring may be formed in as a dotted circle or other similar closed or partially closed curve.

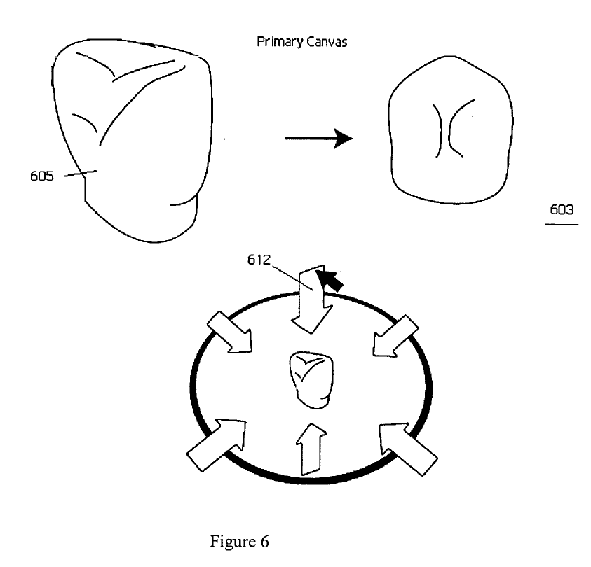

As seen in FIG. 4, once a given tooth number is identified, e.g., preferably from the display odontogram in FIG. 8, a selected tooth image is then displayed in the center portion of the compass tool. Preferably, the tooth image is displayed as a selectable (a clickable) bitmap. In FIG. 4, the tooth image 401 is a biscupid; in FIG. 5, the tooth image 501 is a molar. Of course, there are merely representative images and representative teeth. Preferably, selection of a new tooth image (and placement of that image in the compass tool center) causes a corresponding image (or portion thereof) to be displayed in the primary canvas. Thus, if a user changes tooth numbers (or makes a selection of a new tooth number in a given palette or menu), preferably the tooth image at the center of the compass tool is changed, which, in turn, causes a corresponding new display model to be displayed in the canvas. In this way, the designer can easily switch between teeth and/or designs.

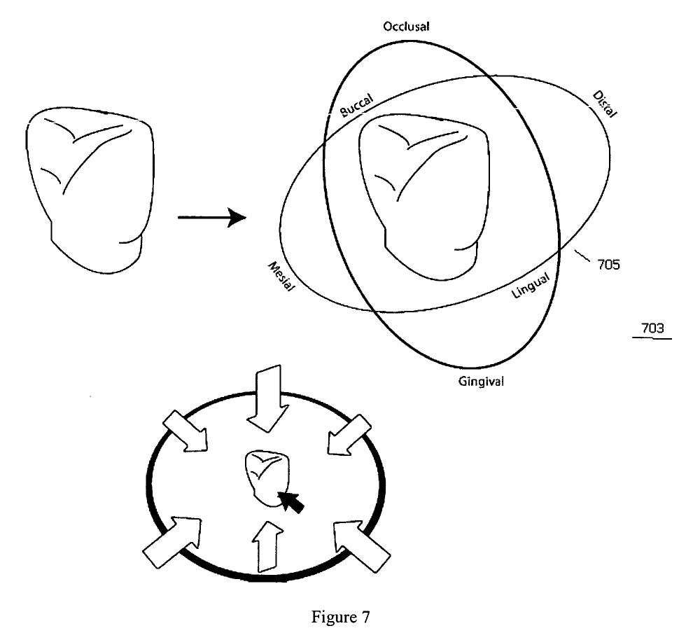

According to a feature of the invention, the selection of a given arrow in the compass tool alters an orientation of the tooth restoration model on the primary canvas to a viewpoint the along the selected anatomical axis. This function is illustrated in FIG. 6. In this example, the user has placed a pointer (e.g., a mouse cursor) on the occlusal arrow 612 and selected the arrow. This causes the bicuspid tooth model 605 on the primary canvas 603 to change from an isometric view to an occlusal view, as depicted. In this manner, the user can easily navigate in and about the tooth model as the model is being designed.

According to a further feature of the invention, as illustrated in FIG. 7, the selection of the given tooth image at the center of the compass tool generates an orientation graphic 705 around the tooth model 705 on the primary canvas 703. The orientation graphic 705 preferably comprises one or more planar rings oriented along the identified aspects.

According to a variation of the present invention, the compass tool need not display all three (3) pairs of orientation arrows at the same time. In the alternative, two (2) pairs (e.g., mesial-distal and buccal-lingual) or even just one pair may be displayed. In such case, one or more of the omitted pairs may then be displayed (e.g., to complete the 6 axis compass) when the user takes a given action (e.g., a mouseover or mouse click) relative to that portion of the compass that is then being displayed.

As another variation, the compass tool may be displayed without the center image or representation of a given tooth, or the image or representation may be displayed in a different position relative to the orientation arrows.

One of ordinary skill in the art will also appreciate that the inventive tool may be used in other display applications wherein an arbitrary position within an x-y or x-y-z coordinate system is desired or required. Thus, for example, the tool may be used to facilitate navigation in any type of 2D or 3D display.

While certain aspects or features of the present invention have been described in the context of a computer-based method or process, this is not a limitation of the invention. Moreover, such computer-based methods may be implemented in an apparatus or system for performing the described operations, or as an adjunct to other dental restoration equipment, devices or systems. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus. The described functionality may also be implemented in firmware, in an ASIC, or in any other known or developed processor-controlled device.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. Further, while given components of the system have been described separately, one of ordinary skill will appreciate that some of the functions may be combined or shared in given systems, machines, devices, processes, instructions, program sequences, code portions, and the like.

Having now described my invention, what I claim is as follows:

1. A computer program product tangibly embodying computer program instructions executable by a processor for carrying out a display method, the method comprising:
displaying a compass tool comprising a center, together with a set of orientation arrows that correspond to pairs of anatomical reference points in a human mouth;
displaying an image of a given tooth in the compass tool center;
displaying a representation of a tooth model; and
responsive to selection of a given arrow associated with an anatomical axis, adjusting an orientation of the tooth model to a viewpoint along the selected anatomical axis.

2. The computer program as described in claim 1 wherein the pairs of anatomical reference points comprise a mesial-distal pair, and wherein the set of orientation arrows include a first arrow identified as mesial, and a second opposed arrow identified as distal.

3. The computer program as described in claim 1 wherein the pairs of anatomical reference points comprise a buccal-lingual pair, and wherein the set of orientation arrows include a first arrow identified as buccal, and a second opposed arrow identified as lingual.

4. The computer program as described in claim 1 wherein the pairs of anatomical reference points comprise a occlusal-gingival pair, and wherein the set of orientation arrows include a first arrow identified as occlusal, and a second opposed arrow identified as gingival.

5. The computer program as described in claim 4 wherein the display method further includes the step of replacing the image of a given tooth in the compass tool center with a different tooth.

6. The computer program as described in claim 5 wherein the display method further includes the step of displaying a new representation of the tooth model in response to the step of replacing the image of the given tooth.

7. The computer program as described in claim 1 wherein the display method further includes the step of selecting the image of the given tooth from a data set.

8. The computer program as described in claim 1 wherein the image is selected from an odontogram, the odontogram comprising a set of clickable graphics, with each graphic corresponding to a given tooth in the data set.

9. The computer program as described in claim 1 wherein the display method further includes the step of superimposing an orientation graphic over the representation of a tooth model in response to selection of the image of a given tooth in the compass tool center.

10. A computer program product tangibly embodying computer program instructions executable by a processor for carrying out a display method, the method comprising:
displaying a tool comprising a center portion, and a set of orientation figures arranged in pairs, the pairs corresponding to pairs of anatomical reference points in a human mouth, wherein the pairs of anatomical reference points comprise a mesial-distal pair, an buccal-lingual pair, and an occlusal-gingival pair;
wherein the tool center portion is adapted to receive a selected one of a set of tooth image representations.

11. The computer program as described in claim 10 wherein the display method further including the steps of:
selecting one of the set of tooth image representations; and
displaying the selected tooth image representation in the tool center portion as a selectable graphic.

12. The computer program as described in claim 11 wherein the display method further including the step of:
displaying a tooth model associated with the selected tooth image; and
responsive to selection of a given orientation figure associated with an anatomical reference pair, adjusting an orientation of the tooth model to a viewing axis associated with the given orientation figure.

13. A computer program product tangibly embodying computer program instructions executable by a processor for carrying out a display method, the method comprising:
displaying a control object comprising a center portion, and a set of one or more orientation figures arranged in pairs about the center portion, the pairs corresponding to one or more orientation axes.
